(19) United States
(12) Patent Application Publication
(10) Pub. No.: US 2019/0286432 A1
(43) Pub. Date: Sep. 19, 2019

(54) INFORMATION PROCESSING SYSTEM, APPARATUS, INFORMATION PROCESSING METHOD, AND RECORDING MEDIUM

(71) Applicant: Masatoshi YANASE, Kanagawa (JP)

(72) Inventor: Masatoshi YANASE, Kanagawa (JP)

(73) Assignee: Ricoh Company, Ltd., Tokyo (JP)

(21) Appl. No.: 16/294,059

(22) Filed: Mar. 6, 2019

(30) Foreign Application Priority Data
Mar. 16, 2018 (JP) 2018-049888

(51) Int. Cl. G06F 8/61; H04N 1/00

(52) U.S. Cl. CPC G06F 8/61; H04N 1/00307; H04N 1/00244

(57) ABSTRACT

An apparatus includes processing circuitry. The processing circuitry installs a first program in the apparatus with reference to a backup of information indicating the first program, installed in the apparatus or another apparatus, obtains information related to a second program different from the first program, and outputs the obtained information.

### CROSS-REFERENCE TO RELATED APPLICATION

This patent application is based on and claims priority pursuant to 35 U.S.C. § 119(a) to Japanese Patent Application No. 2018-049888, filed on Mar. 16, 2018, in the Japan Patent Office, the entire disclosure of which is hereby incorporated by reference herein.

### BACKGROUND

### Technical field

The present disclosure relates to an information processing system, an apparatus, an information processing method, and a recording medium.

### Discussion of the Background Art

There is a restoration method in which a backup of a program such as an application installed on an apparatus is preliminarily stored in a predetermined storage device, and the backup program is restored to a new apparatus at an occurrence of apparatus replacement, so as to enable states of the apparatus before replacement to be restored on the new apparatus.

However, since the conventional restoration aims to restore an original state, the program to be restored is the same as the program for the backup. Therefore, even in a case where a new program with an expanded function has been released at the time of restoration, the user cannot make sufficient use of the convenience of the functional expansion.

### SUMMARY

In an aspect of the present disclosure, there is provided an apparatus that includes processing circuitry. The processing circuitry installs a first program in the apparatus with reference to a backup of information indicating the first program, installed in the apparatus or another apparatus, obtains information related to a second program different from the first program, and outputs the obtained information.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a configuration example of an information processing system 1 according to an embodiment of the present disclosure;

FIG. 2 is a diagram illustrating a hardware configuration example of an image forming apparatus 10 according to an embodiment of the present disclosure;

FIG. 3 is a diagram illustrating a hardware configuration example of an information processing terminal 20 according to an embodiment of the present disclosure;

FIG. 4 is a diagram illustrating a functional configuration example of an information processing terminal 20 and a server apparatus 30 according to an embodiment of the present disclosure;

FIG. 5 is a sequence diagram illustrating an example of a processing procedure of backup processing;

FIGS. 6A and 6B (FIG. 6) illustrate a sequence diagram showing an example of a processing procedure of restore processing; and

FIG. 7 is a diagram illustrating a configuration example of associated information.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

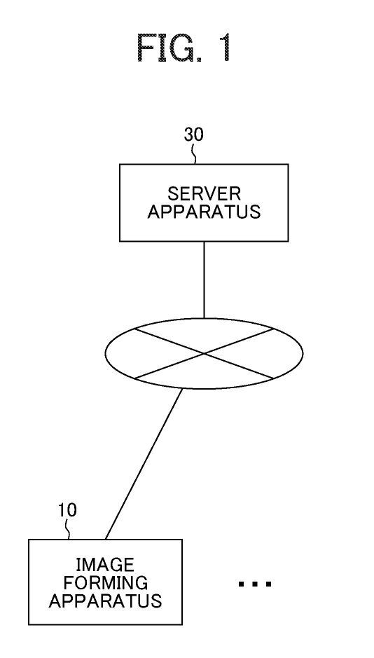

Hereinafter, embodiments of the present disclosure will be described with reference to the drawings. The figure is a diagram illustrating a configuration example of an information processing system 1 according to an embodiment of the present disclosure. As illustrated in FIG. 1, the information processing system 1 includes a server apparatus 30 and one or more image forming apparatuses 10. The server apparatus 30 and each of the image forming apparatuses 10 are connected to each other via a network such as the Internet or a local area network (LAN).

The image forming apparatus 10 is a multifunction peripheral which implements, with a single housing, two or more functions such as printing, scanning, copying, and facsimile transmission/reception. Alternatively, an apparatus having any one of the functions may be used as the image forming apparatus.

The server apparatus 30 includes one or more computers that store a set of applications installable in the image forming apparatus 10.

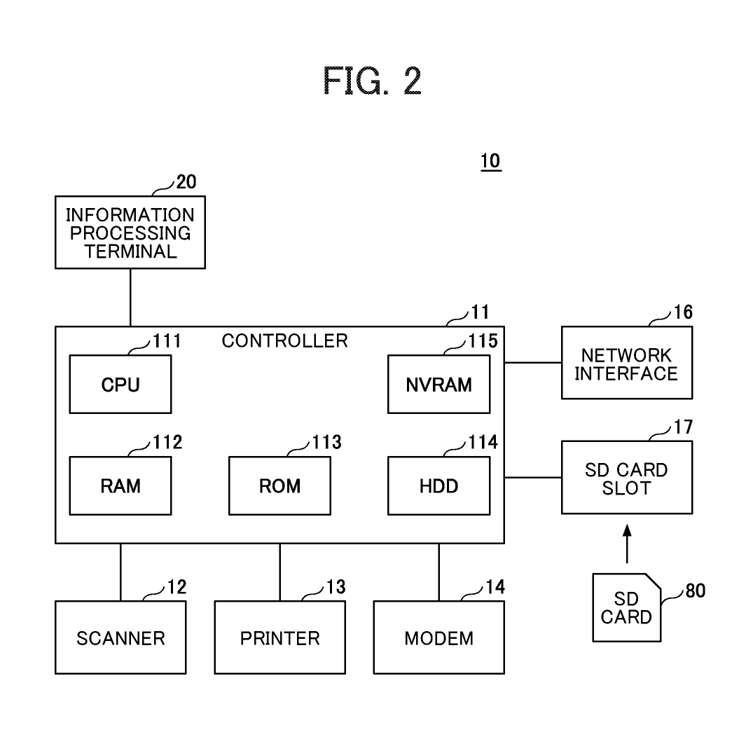

FIG. 2 is a diagram illustrating a hardware configuration example of the image forming apparatus 10 according to an embodiment of the present disclosure. In FIG. 2, the image forming apparatus 10 includes hardware devices such as a controller 11, a scanner 12, a printer 13, a modem 14, a network interface 16, and an SD card slot 17.

The controller 11 includes a controller board (computer) constituting a main body unit of the image forming apparatus 10. The main body unit is a relative expression with respect to the operation unit. In FIG. 2, the controller 11 includes a central processing unit (CPU) 111, a random access memory (RAM) 112, a read only memory (ROM) 113, a hard disk drive (HDD) 114, and a non-volatile RAM (NVRAM) 115. The RUM 113 stores various programs and data to be used by the programs, or the like. The RAM 112 is used as a storage region for loading a program, a work region of a loaded program, or the like. The CPU 111 processes the program loaded in the RAM 112 to implement various functions. The HDD 114 stores programs and various data to be used by the programs. The NVRAM 115 stores various setting information or the like.

The scanner 12 is hardware for reading image data from a document. The printer 13 is hardware for printing data prepared for printing, on a printing sheet. The modem 14 is hardware for connecting to a telephone line, and is used for executing transmission and reception of image data via facsimile communication. The network interface 16 is hardware for connecting to a network such as a LAN (regardless of whether wired or wireless). The SD card slot 17 is used for reading the program stored in the SD card 80. This means that the image forming apparatus 10 can load the programs stored in the SD card 80 in addition to the programs stored in the RUM 113, onto the RAM 112 and execute the programs. Note that the SD card 80 may be substituted with another recording medium (for example, a CD-ROM, universal serial bus (USB) memory, or the like). That is, the type of the recording medium corresponding to the category of the SD card 80 is not limited to a predetermined one. In this case, the SD card slot 17 may be substituted by a hardware device corresponding to the recording medium type.

The controller 11 is also connected with the information processing terminal 20. An example of the information processing terminal 20 includes a device such as a smartphone and a tablet terminal. An example of a smartphone is a terminal having multiple functions such as a call function on a mobile phone, an imaging function on a camera, and a Web information display function like a PC. As an example of the tablet terminal includes a tablet-type terminal functioning as a multifunction terminal like a smartphone.

In the present embodiment, the information processing terminal 20 functions as an operation unit of the image forming apparatus 10. The controller 11 and the information processing terminal 20 are mutually connected via a USB cable, near field communication, or a communication line such as a LAN, for example.

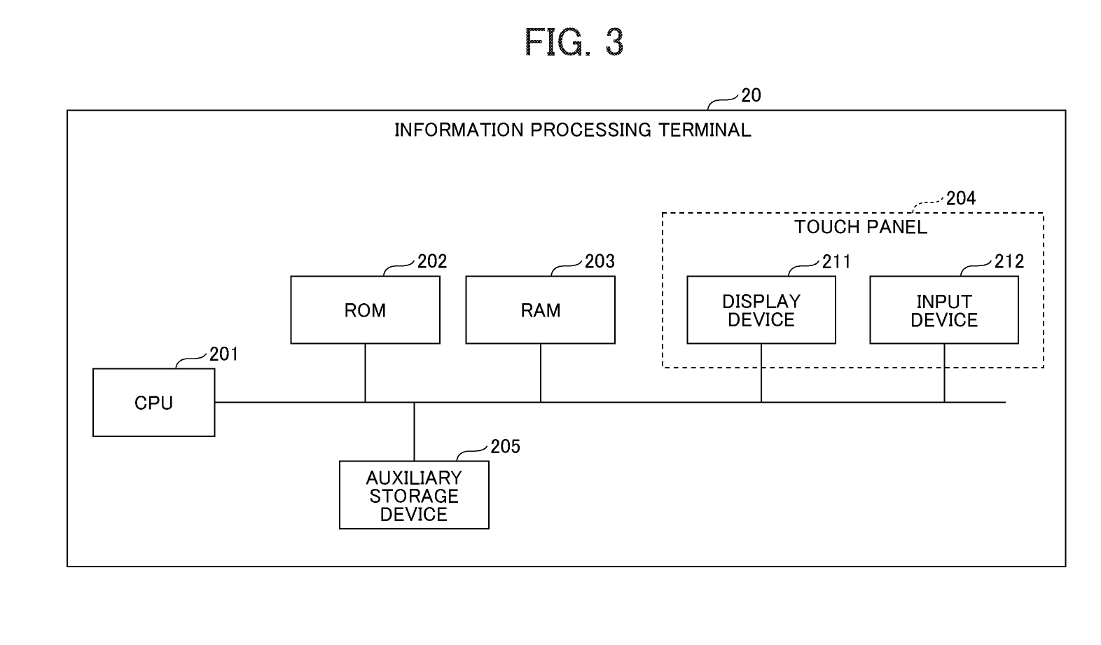

FIG. 3 is a diagram illustrating a hardware configuration example of the information processing terminal 20 according to an embodiment of the present disclosure. In FIG. 3, the information processing terminal 20 includes a CPU 201, a ROM 202, a RAM 203, a touch panel 204, and an auxiliary storage device 205.

The ROM 202 and the auxiliary storage device 205 store programs or the like installed in the information processing terminal 20. In response to an instruction to activate a program, the RAM 203 reads the program from the ROM 202 or the auxiliary storage device 205 and stores in the RAM 203. The CPU 201 implements functions related to the information processing terminal 20 in accordance with the program stored in the RAM 203.

The touch panel 204 is an electronic component having both an input function and a display function, to be used for displaying information, receiving user's input, or the like. The touch panel 204 includes a display device 211 and an input device 212.

The display device 211 is a liquid crystal display or the like, to be used for implementing the display function of the touch panel 204. The input device 212 is an electronic component including a sensor that detects contact of an object coming in contact with the display device 211. The object coming in contact refers to an object that conies in contact with a contact surface (surface) of the touch panel 204. An example of such an object includes user's finger(s), and a dedicated or general pen.

The present embodiment will describe an example in which the information processing terminal 20 is a replacement target in the event of a failure, out of the hardware devices of the image forming apparatus 10 illustrated in FIG. 2.

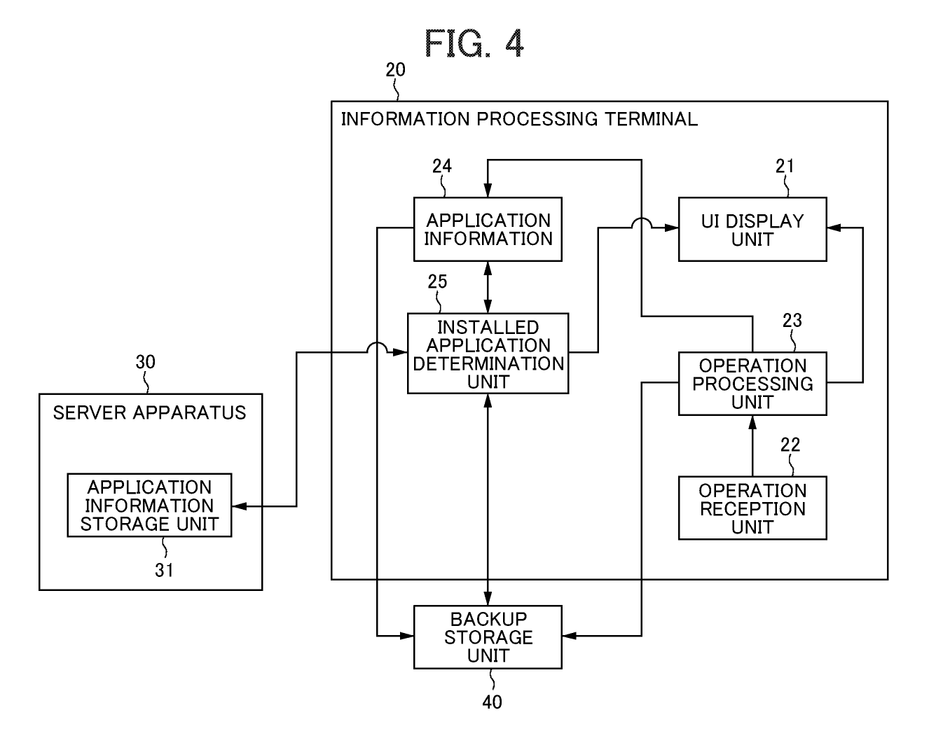

FIG. 4 is a diagram illustrating a functional configuration example of the information processing terminal 20 and the server apparatus 30 according to an embodiment of the present disclosure. In FIG. 4, the information processing terminal 20 includes a UI display unit 21, an operation reception unit 22, an operation processing unit 23, an application management unit 24, and an installed application determination unit 25. These units are implemented by processing executed by the CPU 201 in accordance with one or more programs installed in the information processing terminal 20. The information processing terminal 20 also uses a backup storage unit 40. The backup storage unit 40 can be implemented by using an external storage unit of the information processing terminal 20, examples of the external storage unit including: a recording medium such as an SD card; and a storage device connected to the HDD 114 of the controller 11 or connected to the image forming apparatus 10 via a network.

The UI display unit 21 controls display of a screen or the like for receiving an operation instruction from a user, onto the display device 211.

The operation reception unit 22 detects the operation instruction toward a screen or the like displayed by the UI display unit 21, and notifies the operation processing unit 23 of information (operation information) indicating the operation instruction. An example of the operation information includes information indicating screen elements (buttons etc.) operated by the user.

The operation processing unit 23 controls execution of processing according to the operation information and requests the UI display unit 21 to display a transition destination screen when a screen transition is needed in the processing. For example, when the user has pressed a button for instructing execution of backup or restoration, the operation processing unit 23 requests the application management unit 24 to execute backup processing or restore processing, and requests the UI display unit 21 to display a screen related to backup processing or restore processing.

The application management unit 24 controls execution of backup processing and restore processing. Backup is duplication of information (hereinafter referred to as “application list information”) indicating a list of application program (hereinafter referred to as “application”) generated for the purpose of restoring (restoration of) an application installed in the information processing terminal 20. Backup processing is processing for storing (for retreat) the duplication in a storage location outside the information processing terminal 20. Restore processing is processing of installing each of applications indicated by the application list information as a backup in the information processing terminal 20.

The installed application determination unit 25 generates a backup of the application list information during the backup processing, and controls installation of the application indicated by the backup in the restore processing.

Meanwhile, the server apparatus 30 includes an application information storage unit 31. The application information storage unit 31 stores application information for each of applications installable in the information processing terminal 20. The application information of a certain application includes associated information in addition to application installation data (hereinafter referred to as “installation package”). The associated information refers to information associated with another application recommended to be installed together with the certain application. For example, the other application may be an application that extends the function of the certain application.

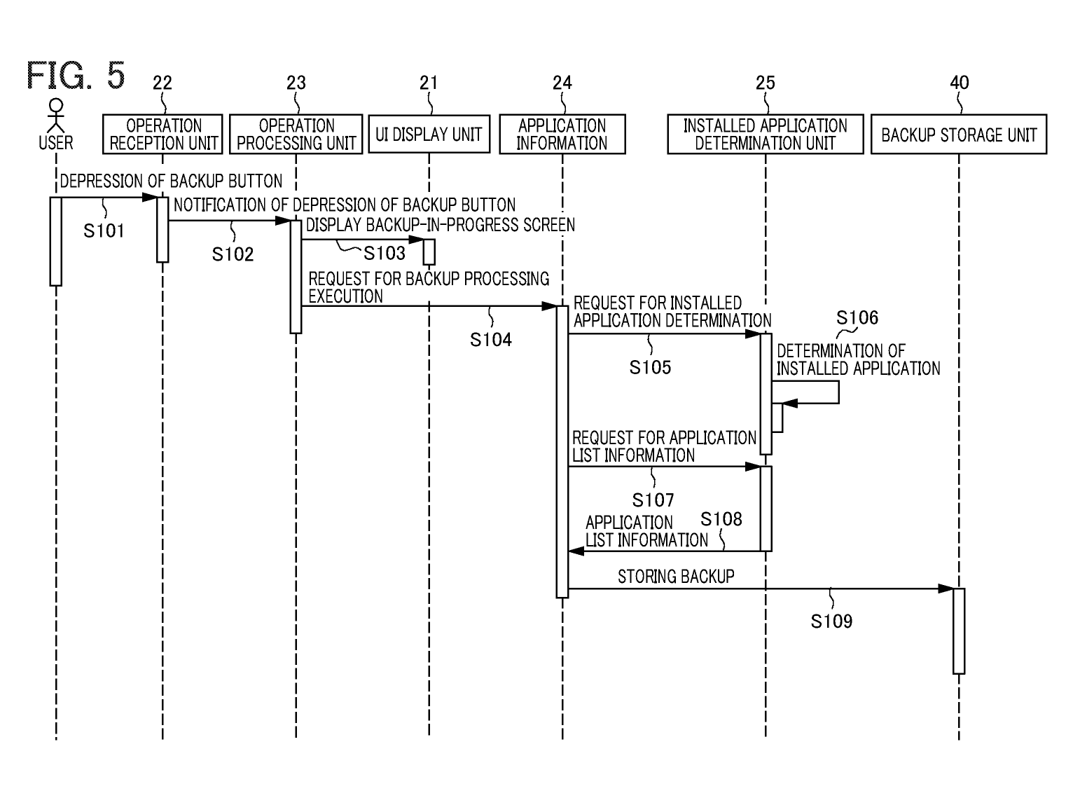

Hereinafter, a processing procedure executed in the information processing system 1 will be described. FIG. 5 is a sequence diagram illustrating an example of a processing procedure of the backup processing.

When the user of the image forming apparatus 10 has pressed a backup button displayed on the display device 211 (S101), the operation reception unit 22 notifies the operation processing unit 23 of the operation information indicating the depression of the backup button (S102). In response to the notification of the operation information, the operation processing unit 23 requests the UI display unit 21 to display a backup-in-progress screen, which is a screen for notifying the user that the backup is in progress (S103). In response to the request, the UI display unit 21 displays the backup-in-progress screen on the display device 211. The operation processing unit 23 also requests the application management unit 24 to execute backup processing (S104).

Subsequently, the application management unit 24 requests the installed application determination unit 25 to determine the list of all the applications installed in the information processing terminal 20 (S105). In response to the request, the installed application determination unit 25 determines the list of the applications installed in the information processing terminal 20, thereby generating the application list information indicating the list (S106). For example, the installed application determination unit 25 may generate a list of identification information (hereinafter referred to as “application name”) of each of applications installed in the auxiliary storage device 205, as application list information. Subsequently, the application management unit 24 requests the installed application determination unit 25 to provide application list information (S107). In response to the request, the installed application determination unit 25 returns, with the application list information generated in step S106, to the application management unit 24 (S108). Subsequently, the application management unit 24 stores the backup of the application list information into the backup storage unit 40 (S109).

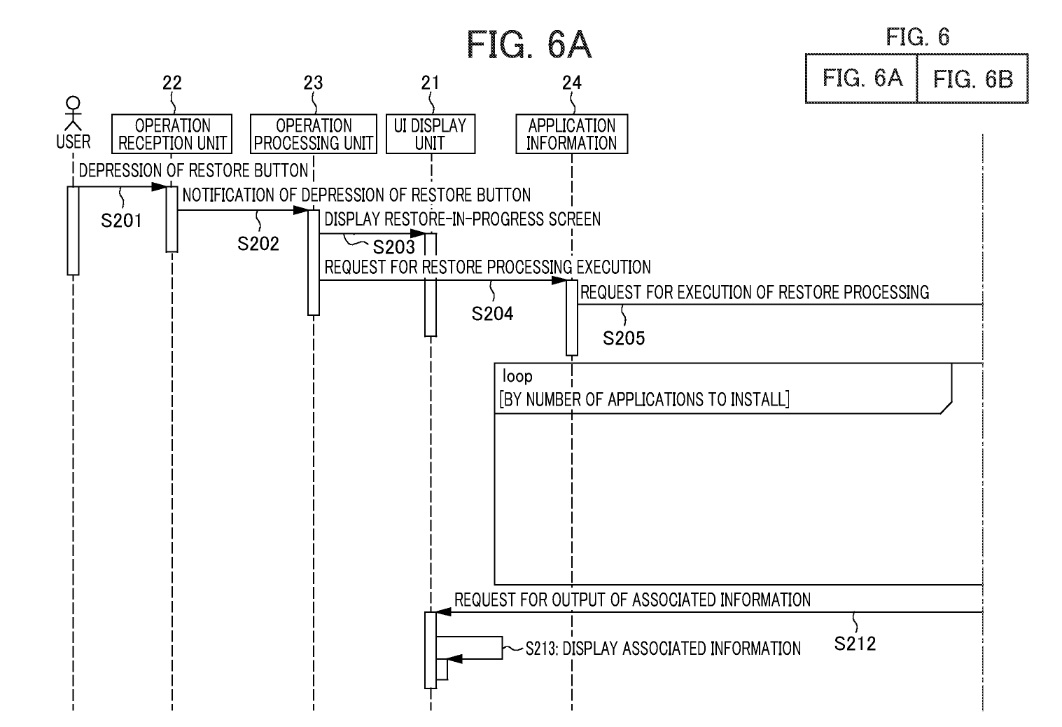

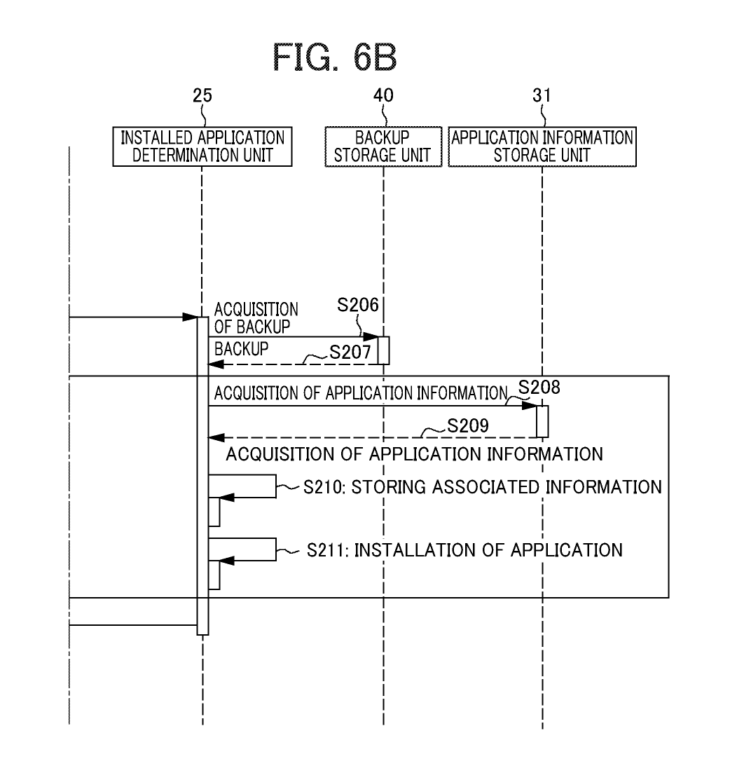

FIG. 6 illustrates a sequence diagram showing an example of a processing procedure of the restore processing. The processing procedure of FIG. 6 may be executed on the same information processing terminal 20 as the information processing terminal 20 that executed the processing procedure of FIG. 5. Alternatively, in a case where the information processing terminal 20 that executed the processing procedure of FIG. 5 has been replaced, the procedure may be executed onto the information processing terminal 20 that has replaced the original one (that is, the information processing terminal 20 different from the information processing terminal 20 which executed the processing procedure of FIG. 5).

When the user of the image forming apparatus 10 has pressed a restore button displayed on the display device 211 (S201), the operation reception unit 22 notifies the operation processing unit 23 of the operation information indicating the depression of the restore button (S202). In response to the notification of the operation information, the operation processing unit 23 requests the UI display unit 21 to display a restore-in-progress screen, which is a screen for notifying the user that the restore is in progress (S203). In response to the request, the UI display unit 21 displays the restore screen on the display device 211. The operation processing unit 23 also requests the application management unit 24 to execute the restore processing (S204), The application management unit 24 requests the installed application determination unit 25 to execute the restore processing (S205).

In response to the request for the execution of the restore processing, the installed application determination unit 25 obtains a backup of the application list information from the backup storage unit 40 (S206 and S207). Subsequently, the installed application determination unit 25 executes steps S208 to S211 for each of the application names included in the application list information (that is, for each of applications to be installed in the restore processing). Hereinafter, an application name as a processing target in one loop of steps S208 to S211 will be referred to as a “target application name”.

In steps S208 and S209, the installed application determination unit 25 obtains, from the application information storage unit 31 of the server apparatus 30, the application information related to the application related to the target application name (hereinafter referred to as “target application”). For example, the application information storage unit 31 stores each of application information in association with an application name.

Subsequently, the installed application determination unit 25 determines whether associated information is included in the obtained application information. In a case where associated information is included, the installed application determination unit 25 stores the associated information into the auxiliary storage device 205 (S210).

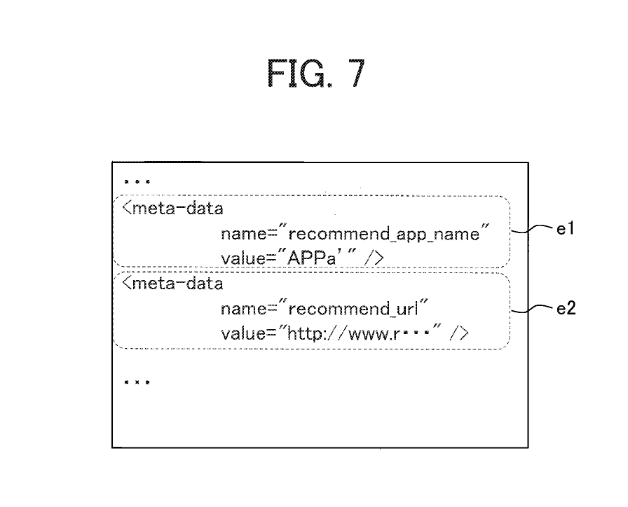

FIG. 7 is a diagram illustrating a configuration example of associated information. While FIG. 7 illustrates an example in which associated information is described by eXtensible Markup Language (XML), the associated information may be described in another format.

The associated information illustrated in FIG. 7 contains two meta-data elements, namely, meta-data elements e1 and e2. The meta-data element e1 indicates that the value of the parameter recommend app name is “APPa′”. Here, reccomend_app_name is a parameter indicating a name of an application recommended to be installed in relation with (together with) the target application (hereinafter referred to as “associated application”). However, the associated application need not have a functional relevance with the target application. A new application that has no functional relevance to the target application may be associated as an associated application with the target application for the purpose of promoting the release of the new application at an occasion of restoring the target application.

in addition, the meta-data element el indicates that the value of the parameter reccomend_url is “http://www.r . . . ”. Here, reccomend_url is a parameter indicating URL of an introduction page of the associated application. Installation processing of the associated application may be activated in response to the operation on the introduction page.

Note that, in addition to reccomend app name and reccomend_url, other information such as fee of the associated application and reasons for recommending the associated application may be included in the associated information.

The server apparatus 30 has the latest updated version of the application at all times. Accordingly, updating the application information stored in the application information storage unit 31 of the server apparatus 30 together with the update to the latest version of the application, or the like, would make it possible to alter the associated information of each of applications without affecting the image forming apparatus 10 side.

Subsequently, the installed application determination unit 25 uses the installation package contained in the application information of the target application to install the target application onto the information processing terminal 20 (S211). This allows, as a result, the installation state regarding the target application in the information processing terminal 20 related to the backup processing to be restored in the information processing terminal 20 related to the restore processing.

After execution of steps S208 to S211 for all the application names included in the application list information, the installed application determination unit 25 requests the UI display unit 21 to output each of pieces of associated information stored in the auxiliary storage device 205 up to the point (S212). At this time, the installed application determination unit 25 may store information indicating that the associated information has already been displayed into the backup storage unit 40 in association with the application name of the target application. In this case, step S210 may be arranged to be selectively executed for the application to which the information is not associated. In a case where restore processing is to be executed on a plurality of information processing terminals 20 using an identical backup storage unit 40, the above-described configuration would make it possible to suppress output of identical associated information for the second and subsequent information processing terminals 20.

Subsequently, the UI display unit 21 displays the associated information on the display device 211 (S213). For example, the display may include a list of reccomend_app_name (application name) of each of associated information, and a screen including a link to reccomend_ url (hereinafter referred to as “associated application screen”) established for each of application names may be displayed on the display device 211.

The user learns the presence (release) of the associated application of each of restored applications with reference to the associated application screen. In addition, operating on the associated application screen for browsing introduction pages of each of associated application and installing the associated application on the information processing terminal 20 would enhance convenience of the information processing terminal 20.

This would also give the developer side of the application an opportunity to notify the user of a new application (associated application).

As described above, according to the present embodiment, it is possible to notify the user of a program different from the restored program.

The method of outputting the associated information is not limited to the display on the display device 211. For example, the installed application determination unit 25 may transmit, in step S212, associated information to the user's e-mail address, or may request the controller 11 to print the associated information.

Furthermore, the associated information to output may be changed in accordance with past use status (use frequency, etc.) of the application. In this case, for example, an output condition may be added to each of pieces of associated information. The output condition is a condition for a use status of the application with which the associated application is associated. For example, the output condition may be the condition that the use count of the application is predetermined number or more. In this case, in the case where the use status of the target application satisfies the output condition attached to the associated information in step S210, the installed application determination unit 25 may store the associated information into the auxiliary storage device 205. The use status of the target application may be stored in the backup storage unit 40. That is, the application management unit 24 may specify, in step S109 of FIG. 5, the use status of each of applications on the basis of log data of each of applications, and may store the information indicating the use status of each of applications into the backup storage unit 40.

Furthermore, the application information storage unit 31 may be implemented by using the HDD 114 of the controller 11. In this case, the controller 11 may periodically download the application information from the server apparatus 30 and update the application information stored in the HDD 114.

In addition, the presence or absence of associated information in each of pieces of application information may be determined by the server apparatus 30. In this case, the server apparatus 30 may determine whether the associated information is included in the application information of the target application, in accordance with step S208. In a case where the associated information is included, the server apparatus 30 may return the installation package of the target application and the associated information to the information processing terminal 20 in step S209.

While the above description is a case of the backup processing and the restore processing related to the application installed in the information processing terminal 20, the present embodiment may be applied to the application installed in the controller 11.

In addition, programs other than the application (such as middleware and firmware, for example) may be the target of backup processing and restore processing.

Furthermore, the present embodiment may be applied to apparatuses other than the image forming apparatus 10, such as a projector, an electronic blackboard, and a video conference system.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

In the present embodiment, the image forming apparatus 10 is an example of an apparatus. The server apparatus 30 is an example of an information processing apparatus.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An apparatus comprising processing circuitry to
install a first program in the apparatus with reference to a backup of information indicating the first program, installed in the apparatus or another apparatus,
obtain information related to a second program different from the first program, and
output the obtained information.

2. The apparatus according to claim 1,
wherein the processing circuitry outputs the obtained information in accordance with the installation of the first program.

3. The apparatus according to claim 1,
wherein the processing circuitry outputs the obtained information in a case where a use status of the first program satisfies a condition for outputting the information related to the second program.

4. An information processing method to be executed by an apparatus, the method comprising:
installing a first program in the apparatus with reference to a backup of information indicating the first program, installed in the apparatus or another apparatus,
obtaining information related to a second program different from the first program, and
outputting the information obtained by the obtaining.

5. A non-transitory recording medium storing a plurality of instructions which, when executed by one or more processors, cause the processors to perform an information processing method, the method comprising:
installing a first program in the apparatus with reference to a backup of information indicating the first program, installed in the apparatus or another apparatus,
obtaining information related to a second program different from the first program, and
outputting the information obtained by the obtaining.
